(19) United States
(12) Patent Application Publication
(10) Pub. No.: US 2008/0320404 A1
(43) Pub. Date: Dec. 25, 2008

(54) METHOD FOR GENERATING OBJECT PROPERTIES RELATED TO USER INTERFACE

(75) Inventors: Tsun-Shao Chen, Taipei City (TW); Shih-Chuan Fu, Chang Hua County (TW); Wei Yu Chen, Taipei City (TW)

Correspondence Address: Muncy, Geissler, Olds & Lowe, PLLC, P.O. BOX 1364, FAIRFAX, VA, 22038-1364, US

(73) Assignee: Realtek Semiconductor Corp.

(21) Appl. No.: 12/143,468

(22) Filed: Jun. 20, 2008

(30) Foreign Application Priority Data
Jun. 21, 2007 (TW) 096122214

(51) Int. Cl. G06F 3/048

(52) U.S. Cl. 715/763

(57) ABSTRACT

A method for generating an object attribute related to a user interface of a digital displaying device is disclosed. The method includes: utilizing a development tool to develop the user interface to generate an editing result; checking the editing result according to a checking rule of the development tool to determine whether the user interface complies with hardware configuration of the digital displaying device, wherein the checking rule corresponds to the hardware configuration of the digital displaying device; generating the object attribute of the user interface according to the editing result; storing the object attribute of the user interface into a description file.

### BACKGROUND OF THE INVENTION

1. Field of the Invention

The present invention relates to a displaying device, and more particularly, to a digital displaying device and its development tool for user interface.

2. Description of the Related Art

A digital displaying device (for example, an LCD display or an LCD TV) often has a lot of functions. Therefore, for being able to efficiently control all of these complex functions, an easy to use user interface (UI), for example, an OSD (on screen display), is required. A microprocessor, which can also be called as micro-controller, e.g., such as an Intel 8051 series, inside the digital displaying device reads and executes firmware stored inside a memory to show the OSD on the digital displaying device such that the user is able to perform some personal settings operations (for example, to adjust the luminance of the digital displaying device or the color of the digital displaying device) through the OSD UI.

From the above illustration, it can be seen that the OSD has become a very essential part of the digital displaying device. In fact, the convenience and the design and appearance (i.e., surface) of the OSD have become factors in attracting consumers to the digital displaying device. Therefore, the development of the OSD should also be an important factor for the suppliers of such devices.

However, the related information of the surface (such as sizes, colors, and fonts) and the contents (such as fonts, languages, and words) of the user interface reside in firmware. The development of the user interface is quite similar to that of conventional firmware. Please refer to FIG. 1. FIG. 1 is a flow chart showing a development process of a conventional firmware. As shown in FIG. 1, the firmware developer first edits source codes 100. The source codes 100 include the source codes of the user interface. After the source codes 100 are completely developed, a complier is used to compile the source codes to generate executable binary codes (i.e., the firmware) 110, which can be executed by the microprocessor.

At last, the executable file 110 is stored to the memory of the digital displaying device. In this way, the microprocessor inside the digital TV can execute the above-mentioned firmware 110 such that the digital displaying device can work correctly (for example, the digital displaying device is able to show the user interface correctly).

Unfortunately, the above-mentioned process is not really convenient for the firmware developer, especially when the developer wants to revise few parts of the firmware, such as the surface and/or content of the user interface. For example, if the firmware developer wants to revise how the user interface appears (i.e., such as the color of a specific graphic or a font used in the user interface), then the firmware developer needs to reedit the source codes 100 and then recompile the reedited source codes 100.

Furthermore, it is not convenient to debug the source codes. For example, there may be a lot of bugs in the source codes 100, if the firmware developer cannot debug them in one attempt, then the firmware developer has to compile the source codes 100 every time after attempts are made to resolve some of the bugs to verify the reedited source codes 100. In other words, in the debug process, all of the source codes are repeatedly compiled. This is not efficient. Moreover, the reedited source codes 100 may be incorrect thereby affecting other functions. Therefore, all of the functions should be verified again. This is also a very time-consuming process.

In addition, the digital TV often has some hardware limitations. Therefore, the firmware developer has to develop the firmware according to the hardware limitations such that the digital TV can definitely support the developed firmware. But, the firmware developer and the hardware developer of the digital TV are not always the same developer (i.e., companies). This means that the firmware developer may be unfamiliar with the hardware limitations of the digital TV. This makes it more difficult to develop the firmware. This may necessitate more time in the development process and thereby reduce the development process efficiency.

Furthermore, the various digital displaying devices may each have different sizes and resolutions. Therefore, a digital displaying device having a specific size and a specific resolution should correspond to an OSD having an appropriate size. In other words, even if the digital displaying devices have the same functions and OSDs, because the sizes of the displays are different, the sizes of OSDs should also be properly adjusted.

Therefore, it is apparent that new and improved methods and devices are needed.

### SUMMARY OF THE INVENTION

In view of the above-mentioned problems, one of the objects of the claimed invention is to provide a firmware development tool and related digital displaying device.

Another object of the claimed invention is to provide a firmware development tool capable of in-time checking the editing result complies with the hardware configurations when the editing result is being edited to solve the above mentioned problems.

Another object of the claimed invention is to provide a data structure of firmware for easily adjusting the firmware to solve the above-mentioned problems.

Another object of the claimed invention is to provide a data structure of firmware for easily changing the settings of the firmware according to the hardware to solve the above-mentioned problems.

According to one embodiment of the claimed invention, a method for generating an object attribute related to a user interface of a digital displaying device is disclosed. The method comprises: utilizing a development tool to develop the user interface to generate an editing result; checking the editing result according to a checking rule of the development tool to determine whether the user interface complies with hardware configuration of the digital displaying device, wherein the checking rule corresponds to the hardware configuration of the digital displaying device; generating the object attribute of the user interface according to the editing result; storing the object attribute of the user interface into a description file.

According to one embodiment of the claimed invention, a digital displaying device is disclosed. The displaying device comprises: a storage device, storing a data portion and a program portion, wherein the data portion comprises a description file, and the program portion comprises a parser program and an application program; and a processing unit, coupled to the storage device, for executing the application program and the parser program, wherein the processing unit parses the description file to obtain at least one object attribute according to the parser program, and controls the digital displaying device according to the object attribute and the application program.

According to one embodiment of the claimed invention, a method for generating a user interface of digital displaying device is disclosed. The digital displaying device comprises a storage device and a processing unit, the storage device storing a data portion and program portion. The data portion comprises a description file, and the program portion comprises a parser program and an application program. The method comprises: utilizing the processing unit to execute the application program to control the digital displaying device; utilizing the processing unit to execute the parser program to parse the description file inside the storage device to obtain at least one object attribute of the user interface, wherein the description file is related to the user interface of the digital displaying device; and displaying the user interface on the digital displaying device according to the object attribute.

### BRIEF DESCRIPTION OF THE DRAWINGS

FIG. 1 is a flow chart illustrating a conventional development process of a firmware.

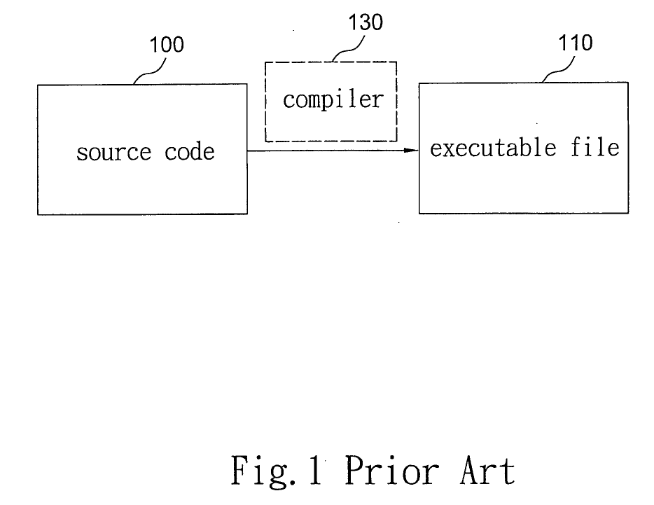

FIG. 2 is a diagram illustrating the development of the user interface according to an embodiment of the present invention.

FIG. 3 is a diagram illustrating the development environment of the graphic development tool.

FIG. 4 illustrates an entire preview display and a single-layer preview display provided by the graphic interface development tool.

FIG. 5 illustrates how the graphic interface is described in the description file according to an embodiment of the present invention.

FIG. 6(a) illustrates a parser based on the hardware structure.

FIG. 6(b) is a flow chart illustrating how the OSD is displayed at different resolutions.

### DETAILED DESCRIPTION OF THE INVENTION

Generally speaking, the user interface of a digital displaying device (e.g., a digital TV) is displayed as an on-screen display (OSD). Furthermore, the manufacturer of the digital displaying device may want to develop different types of OSDs for various models of the digital displaying devices. These OSDs may vary in only minor ways, such as having different shapes of the buttons or fonts and colors.

According to the above-mentioned demands, the present invention provides a firmware developing process, which divides the development of firmware into two parts, the data part and the function part. Herein, the firmware developer does not need to compile the entire source codes each time when the firmware developer reedits the source codes. Instead, if development of the function portion of the firmware has been completed, for subsequent development, the developer can focus on the data part (e.g., the graphic interface UI) of firmware without affecting other functions of firmware.

Moreover, for the development of OSD, the present invention also discloses a development tool, which allows the firmware developer to execute development more easily.

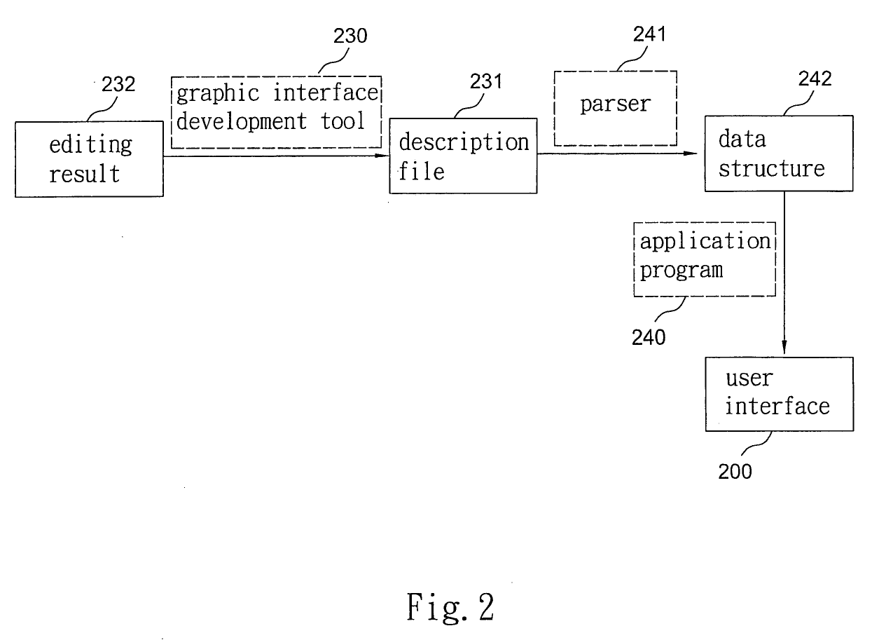

Please refer to FIG. 2. FIG. 2 is a diagram illustrating the development of the user interface 200 according to the present invention. As shown in FIG. 2, the firmware developer uses a graphic interface development tool 230 to develop the graphic interface of the user interface. These elements may include the OSD graphics, buttons, fonts, etc.

After the development process is completed, the graphic interface development tool 230 outputs a description file 231 according to the editing result 232, which corresponds to the editing result 232.

For example, the editing result 232 comprises information about the size, color, and location of each graphic object. The above-mentioned description file 231 describes the properties (e.g., length, width, color, and initial position) of each graphic object. In this embodiment, the description file 231 can be an XML file or an ini file. In addition, the description file 231 contains color information and position information for each of the graphic objects and information corresponding to the size and type of strings or fonts. For example, in an XML file, “tags” can store the properties of a graphic object. Furthermore, the description file 231 also stores codes of graphic objects and a mapping relationship between codes of graphic objects and their corresponding graphic objects in the graphic interface development tool 230. Furthermore, an ini file is similar to a note (i.e., text) file, which can be used to modify parameters of an executable file. In other words, the ini file can be open by a normal note (i.e., text) editing software program. If the developer wants to make the firmware generate the desired result, the developer can directly modify the description file 231 to achieve the purpose. After the ini or XML file is modified, the desired result will be generated when the microprocessor executes the firmware again and the ini file or the XML file is read.

The firmware and the description file 231 are then stored into a memory device of the digital TV such as a flash memory or a ROM.

When the digital displaying device is activated, the microprocessor reads (e.g., from the memory device) and executes a main program 240 (e.g., the application software program) to execute a series of instructions. Furthermore, the microprocessor of the digital TV further executes a parser 241, which was previously stored inside the memory device. The parser 241 is used to read the description file 231 such that the information contained in the description file 231 is converted into a data structure 242 capable of being read by a program (e.g., the application software program).

Therefore, the microprocessor can understand the locations and other information contained inside the description file 231 and combine this information with the functions of the user interface contained within the application program 240 itself. In this way, a complete user interface can be implemented and displayed for use by a user.

From the above disclosure, it can be seen that the present invention divides the development of the user interface into two parts, a data part and a function part. The data part (i.e., the parameters of each object) of the user interface is developed by using a dedicated graphic interface development tool 230 to generate the description file 231. The function part (i.e., including the functions of the user interface) is already stored into the application program 240 itself and then integrated with the data part.

As mentioned previously, for a same hardware configuration, only one application software program 240 is needed. The graphic interface development tool 230 is utilized to make the user interface comply with the hardware configuration and define appropriate object parameters to generate the user interfaces having different graphic interfaces. Surely, the application program 240 can be provided by the hardware supplier of the digital TV such that the firmware developer only needs to focus on the design of graphic interface. This significantly increases the efficiency of the development of the user interface.

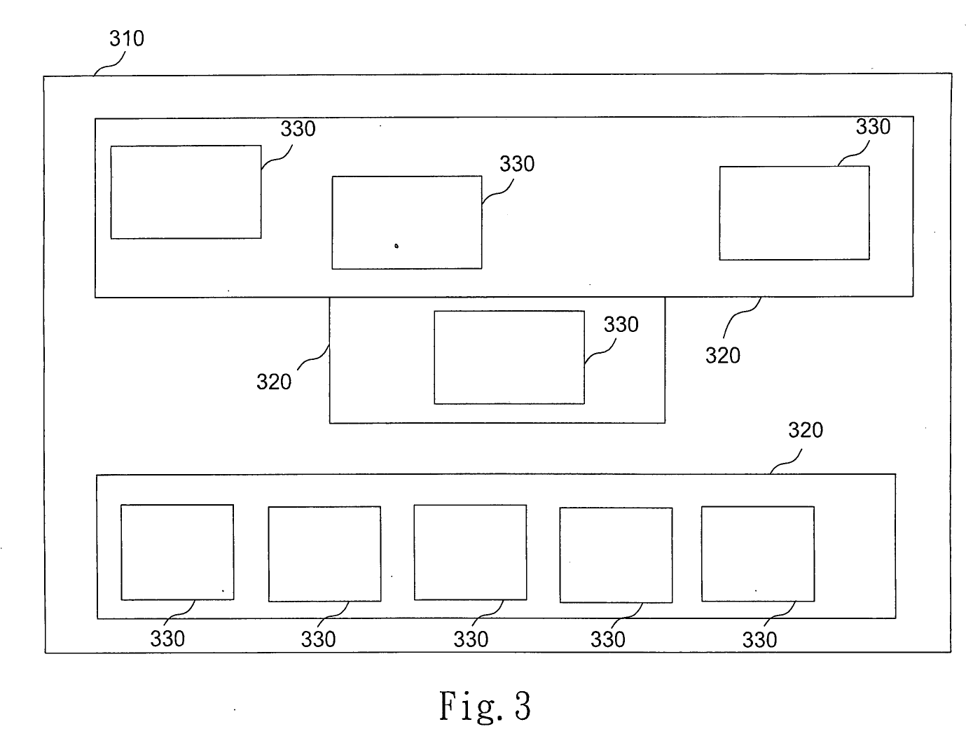

Please note, the graphic interface development tool 230 is a software program, which can be executed by a personal computer to generate a development environment. Please refer to FIG. 3, which is a diagram of the development environment of the graphic development tool 230. In this embodiment of the present invention, the graphic interface development tool 230 is a “what you see is what you get” tool. Therefore, the firmware developer can easily see the editing result through the graphic interface development tool 230. In other words, the developer can use the graphic objects and font objects embedded in the graphic interface development tool 230 to directly create the surface (i.e., appearance) of the user interface. For example, the developer can use a mouse to change shape, position, and size attributes of each of the graphic object such that the user interface is modified.

Please note, the resulting user interface must comply with the hardware configuration of the digital TV. Therefore, the present invention graphic interface development tool 230 embeds some checking rules dependent to the hardware configuration of the digital TV into the graphic interface development tool 230. In the development process, these checking rules can be used to in-time check whether an invalid editing result exists (for example, an editing result that the digital TV cannot support) to ensure that the developed user interface complies with the hardware configuration of the digital TV.

In other words, the present invention graphic interface development tool 230 is different from the prior art. The graphic interface development tool 230 is able to in-time check the editing result to prevent from generating incorrect parameters. This means that the developer can immediately know the bugs of the editing result without compiling the entire source codes. In this way, the source codes (or editing results) do not need to be repeatedly compiled. This increases the development efficiency.

For example, the OSD of the digital displaying device may show the graphics by different layers, sections, or zones. Therefore, as shown in FIG. 3, in this embodiment of the present invention, the graphic interface development tool 230 can be implemented according to the hardware of the digital TV. It means that the graphic interface development tool 230 also has several graphic objects, such as layers 310, sections 320, and zones 330 as shown in FIG. 3. At this time, if the hardware configuration has some limitations (e.g., the number of zones in a single zone cannot exceed a certain threshold, etc.), the corresponding checking rules are embedded in the graphic interface development tool 230. In this way, when the developer puts too many zones in a zone, the graphic interface development tool 230 tells the firmware developer that the allocation of the graphic objects is invalid and the added zone is rejected.

Surely, the graphic interface development tool 230 may have more checking rules according to the supporting ability of the hardware. For example, these checking rules may be: two zones cannot overlap, a zone must be inside a layer, a zone must be inside a section, a maximum number of layers, a maximum number of sections, a maximum number of zones, or a maximum number of sections along a horizontal line.

In this way, the firmware developer does not need to worry about whether hardware of the digital displaying device supports the editing result. In other words, the object parameters of the description file 231 must be supported by the hardware of the digital TV.

From the above, because the graphic interface development tool 230 can help the firmware developer to check the bugs, the firmware developer can directly design the user interface without being familiar with the hardware limitations of the digital displaying device, such as the resolution of a frame. This further increases the development efficiency.

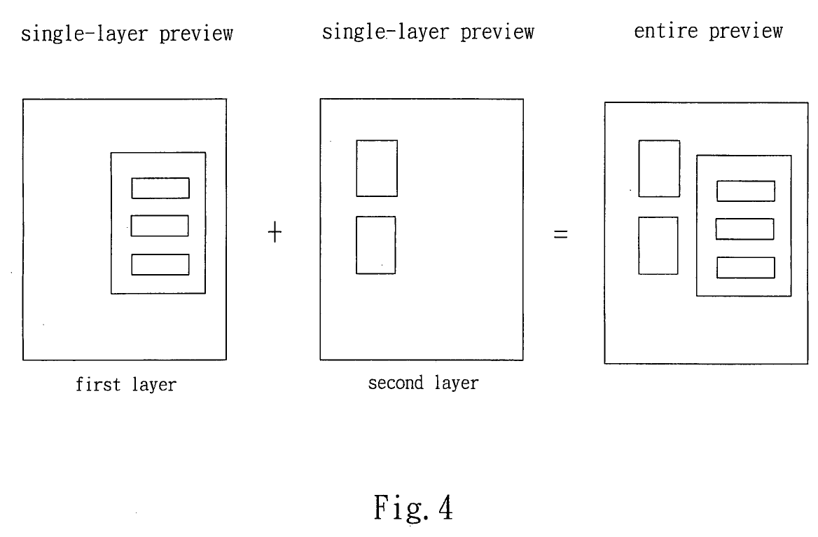

Moreover, please note, in the above-mentioned cases, the digital TV mixes and overlaps these data (e.g., zones and sections) of different layers to display the user interface. Therefore, the graphic interface development tool 230 also provides a preview function accordingly. Please refer to FIG. 4. FIG. 4 depicts an entire preview display and a single-layer preview display provided by the graphic interface development tool 230.

As shown in FIG. 4, the single-layer preview display allows the developer to see the display result of a single layer (e.g., the first layer or the second layer in FIG. 4) or the display result of multiple overlapped layers. Additionally, the entire preview display allows the developer to see the actual effect that the digital displaying device will display to the end user. That is, the entire preview display shows the overlapped display result of all layers to the developer. In this way, the developer can allocate each of the graphic objects more accurately to achieve a better effect.

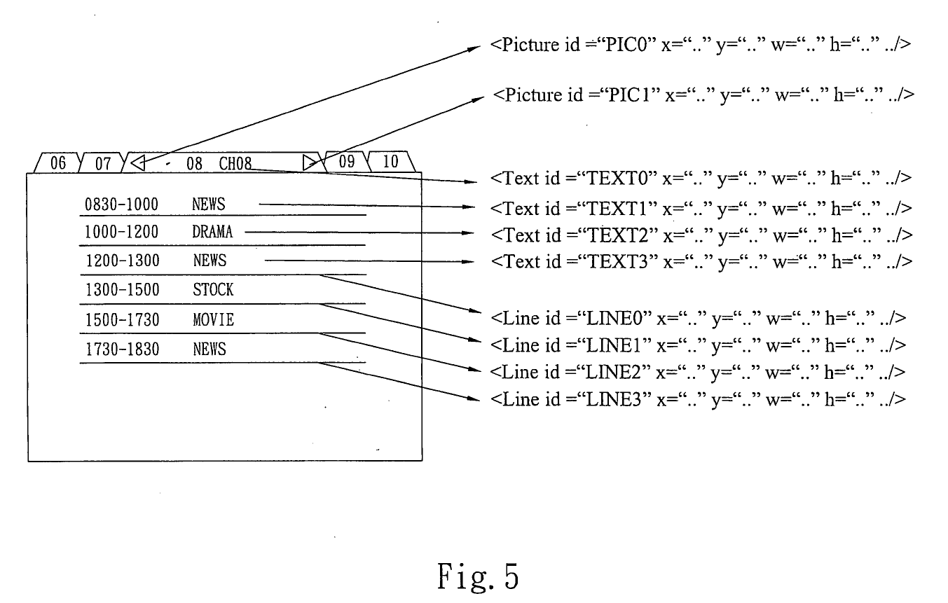

After the developer completely edits the graphic interface, the graphic interface development tool 230 generates the above-mentioned description file. Please refer to FIG. 5. FIG. 5 depicts how the graphic interface is described in the description file according to the present invention. As shown in FIG. 5, each graphic and font corresponds to a tag, which records an ID (e.g., PIC0 and TEXT0) corresponding to the graphic or font and corresponding coordinates such as x, y, w, and h. Therefore, as shown in FIG. 5, through the description file, the positions and attributes of the graphics and fonts of the user interface can be known.

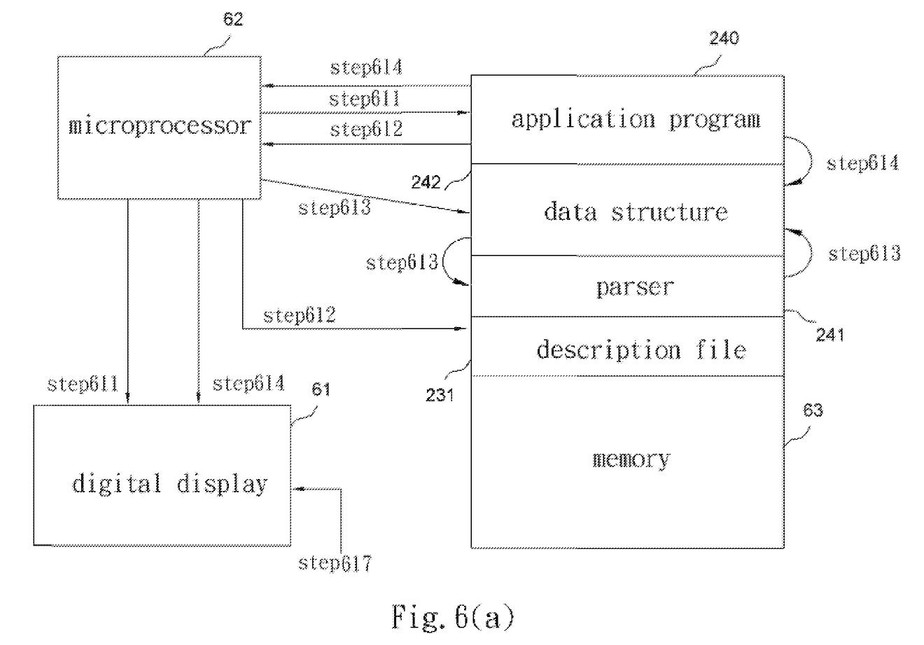

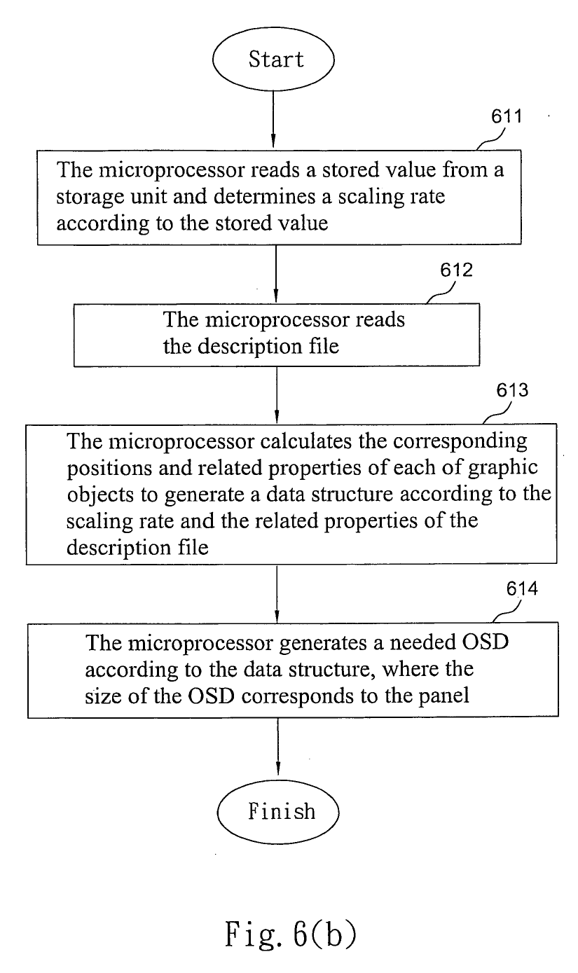

In addition, the present invention can be used in panels (i.e., hardware of the digital TV) having different sizes or resolutions. Please refer to FIG. 6(a), which illustrates a parser 241 by using a hardware structure. As shown in FIG. 6(a), the digital displaying device comprises a digital display 61, a microprocessor 62, and a memory 63. The memory 63 stores a data part and a program part. The program part comprises an application program 240 and parser 241, and the data part comprises a description file 231. Please refer to FIG. 6(b), which is a flow chart illustrating the process of how the OSD is displayed in different resolutions. It comprises following steps:

Step 611: The microprocessor reads a stored value (representing the resolution of the panel) from a storage unit and determines a scaling rate according to the stored value;

Step 612: The microprocessor reads the description file;

Step 613: The microprocessor calculates the corresponding positions and related properties of each of the graphic objects to generate a data structure according to the scaling rate and the related properties of the description file; and

Step 614: The microprocessor generates a needed OSD according to the data structure, where the size of the OSD corresponds to the panel.

In the above-mentioned embodiment of the present invention, the application software program 240 and the parser 241 are realized separately and perform their functions independently. But, the parser 241 can be implemented inside the application software program 240. In other words, the parser 241 can also be part of the application software program 240. That is, the parser 241 can be a sub-program of the application software program 240. This change also obeys the spirit of the present invention.

Furthermore, in step 614, the parser 241 further establishes a resource manager according to the mapping relationship contained in the description file 231. For example, the resource manager can include a mapping table storing the mapping relationship of the resources (e.g., the corresponding relationships between the graphics, strings, fonts and corresponding codes). For instance, the resource manager can have a corresponding relationship between a code and its meaning (e.g., for a color, an ID inside an XML file may be COLOR1 and it can be converted to a program-executable data “red” in the data structure; for a graphic, an ID inside an XML file may be PIC1 and it can be converted to an address of the memory or codes in the data structure). Therefore, the parser 241 can generate an executable data structure 242 for the application software program 240 according to the resource manager and the calculated positions and related properties of each graphic object.

In the prior art, the firmware developer has to know the resolution of the digital displaying device and modify the size and the coordinates of each graphic object according to that known resolution. But in this embodiment of the present invention, the firmware developer only needs to use the graphic interface development tool 230 to draw the desired graphics such that an appropriate user interface is developed.

Please note, additionally, the firmware developer can use the embedded graphics and fonts inside the graphic interface development tool 230 and the firmware developer can import any needed fonts and graphics. This is easily accomplished and is well-known to those having average skill in this art. For example, as long as the graphics and fonts are imported into the graphic interface development tool 230 and the corresponding relationships and their corresponding codes are added into the graphic interface development tool 230, the graphic interface development tool 230 is able to store the codes corresponding to the added graphics and/or fonts into the description file. Furthermore, the parser 241 can also establish the resource management of the added graphics and/or fonts. In this way, the firmware developer can smoothly use the added graphics and/or fonts. This change also falls in the scope of the present invention.

Those skilled in the art can understand and implement the above-mentioned graphic interface development tool, the parser, and the application software program, and further illustrations of developing them are omitted herein.

Please note, although the firmware developer uses the graphic interface development tool to generate the description file (e.g., ini file and the XML file) in the above embodiment, this is only regarded as an embodiment, not a limitation of the present invention. For example, in the actual implementation, the firmware developer can directly edit the description file. This also obeys the spirit of the present invention.

In contrast to the prior art, the present invention allows the firmware developer to focus on the development of the graphic interface without developing the functions of the user interface. In addition, the firmware developer does not have to worry about the relationship between the user interface and the resolution of the digital displaying device. The parser can perform related modifications. This increases development efficiency.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A method for generating an object attribute related to a user interface of a digital displaying device, the method comprising:
utilizing a development tool to develop the user interface to generate an editing result;
checking the editing result according to a checking rule of the development tool to determine whether the user interface complies with a hardware configuration of the digital displaying device, wherein the checking rule corresponds to the hardware configuration of the digital displaying device;
generating the object attribute of the user interface according to the editing result; and
storing the object attribute of the user interface into a description file.

2. The method of claim 1, wherein the step of checking the editing result according to the checking rule of the development tool comprises:
checking the editing result real time according to the checking rule while the editing result is being edited.

3. The method of claim 1, wherein the object attribute comprises a plurality of font object attribute and a plurality of graphic object attribute.

4. The method of claim 1, further comprising:
importing needed font objects and needed graphic objects into the development tool.

5. The method of claim 1, wherein the development tool provides at least one of a plurality of graphic objects and a plurality of font objects.

6. The method of claim 5, wherein the step of checking the editing result according to the checking rule of the development tool comprises:
checking whether a number and a size of the graphic objects in the user interface are valid according to the checking rule; and
checking whether an allocation of the graphic objects in the user interface is valid according to the checking rule.

7. The method of claim 5, wherein the step of checking the editing result according to the checking rule of the development tool comprises:
checking whether a number and a size of the font objects in the user interface are valid according to the checking rule; and
checking whether an allocation of the font objects in the user interface is valid according to the checking rule.

8. The method of claim 1, further comprising:
determining a scaling rate according to a resolution of the digital displaying device; and
utilizing the scaling rate to adjust positions and sizes of objects.

9. The method of claim 1, wherein the object attribute comprises a color of at least one of at least one graphic object and at least one font object.

10. The method of claim 1, wherein the user interface is an OSD (on screen display).

11. The method of claim 1, further comprising:
providing a source manager having a mapping table to manage allocations of the graphic objects and font objects and relationships between the graphic objects and font objects inside the description file to generate a data structure.

12. A digital displaying device comprising:
a storage device, storing a data portion and a program portion, wherein the data portion comprises a description file, and the program portion comprises a parser program and an application program; and
a processing unit, coupled to the storage device, for executing the application program and the parser program, wherein the processing unit parses the description file to obtain at least one object attribute according to the parser program, and controls the digital displaying device according to the object attribute and the application program.

13. The digital displaying device of claim 12, wherein the description file is related to a user interface of the digital displaying device, and the object attribute is related to at least one object attribute of the user interface.

14. The digital displaying device of claim 12, wherein the processing unit determines a scaling rate according to a resolution of the digital displaying device.

15. The digital displaying device of claim 14, wherein the processing unit generates the at least one object attribute according to the parser program and the scaling rate.

16. The digital displaying device of claim 14, wherein the description file stores a position and a size of at least one object, and the processing unit adjusts the size and the position of the object according to the scaling rate.

17. The digital displaying device of claim 12, wherein the description file stores a size of the user interface, and the processing unit adjusts the size of the user interface according to a resolution of the digital displaying device.

18. The digital displaying device of claim 12, wherein the processing unit executes the parser program to select a graphic object having a predetermined size according to the scaling rate.

19. The digital displaying device of claim 12, wherein the user interface is an OSD (on screen display).

20. The digital displaying device of claim 12, wherein the description file stores a color of at least one of at least one graphic object and at least one font object in the user interface.

21. A method for generating a user interface of digital displaying device, the digital displaying device comprising a storage device and a processing unit, the storage device storing a data portion and program portion, the data portion comprising a description file, the program portion comprising a parser program and an application program, the method comprising:
utilizing the processing unit to execute the application program to control the digital displaying device;
utilizing the processing unit to execute the parser program to parse the description file inside the storage device to obtain at least one object attribute of the user interface, wherein the description file is related to the user interface of the digital displaying device; and
displaying the user interface on the digital displaying device according to the object attribute.

22. The method of claim 21, further comprising:
utilizing the processing unit to determine a scaling rate according to a resolution of the digital displaying device.

23. The method of claim 22, further comprising:
utilizing the processing unit to generate the object attribute according to the scaling rate.

24. The method of claim 22, wherein the description file stores a position and a size of at least one font object of the user interface, and the method further comprises:
utilizing the processing unit to adjust the position and the size of the font object according to the scaling rate.

25. The method of claim 22, wherein the description file stores a size of the user interface, and the method further comprises:
utilizing the processing unit to adjust the size of the user interface according to the scaling rate.

26. The method of claim 21, wherein the user interface is an OSD (on screen display).
